(19) United States
(12) Patent Application Publication
(10) Pub. No.: US 2016/0335562 A1
(43) Pub. Date: Nov. 17, 2016

(54) Likelihood of Success of a Remote Document Service

(71) Applicant: HEWLETT-PACKARD DEVELOPMENT COMPANY, L.P., Houston, TX (US)

(72) Inventors: Jun ZENG, Palo Alto, CA (US); Patrick O. SANDFORT, Vancouver, WA (US); Qing DUAN, Palo Alto, CA (US); Gary J. DISPOTO, Palo Alto, CA (US)

(21) Appl. No.: 15/112,925

(22) PCT Filed: Jan. 21, 2014
(86) PCT No.: PCT/US2014/012348

§ 371 Date: Jul. 20, 2016

(51) Int. Cl. G06N 99/00; H04N 1/32; H04N 1/00

(52) U.S. Cl. CPC G06N 99/005; H04N 1/00344; H04N 1/32096; H04N 2201/0039

(57) ABSTRACT

Examples disclosed herein relate to a likelihood of success of a remote document service. For example, a processor may determine to transmit information about a remote document service to a device based on a likelihood of success associated with the ability of the device to perform the remote document service. The likelihood of success may be based on the performance history of the device and a factor associated with performance history and likelihood of success

### BACKGROUND

A document service may be performed at a device remote from the requesting device as part of a cloud service. For example, a user without a printer may request that a document be printed at a remote device. The user may select to print, and the print job may be sent to the remote printer. In some cases, an electronic device may request permission from a remote device associated with a cloud service to receive permission to perform a document service, such as part of a subscription service.

### BRIEF Description OF THE DRAWINGS

The drawings describe example embodiments. The following detailed description references the drawings, wherein;

FIG. 1 is a block diagram illustrating one example of a computing system to determine the likelihood of success of a remote document service.

FIG. 2 is a flow chart Illustrating one example of a method to determine the likelihood of success of a remote document service,

FIGS. 3A, 3B, and 3C are diagrams Illustrating examples of determining the likelihood of success of remote document services.

### DETAILED DESCRIPTION

In one implementation, the likelihood of success of a remote document service may be determined based on historical performance information related to a device. For example, a document may be sent to a device for printing, and the historical information may include information related to whether the device was successful in performing a remote document service previously when the device status was the same or similar to the current device status.

The likelihood of success of the remote document service may be determined such that the remote device receives an instruction to perform the service is likely to successfully perform the service at a future time. In some cases, the services are scheduled for a later point in time such that rescheduling adds greater inefficiency. Selecting devices with a greater likelihood of success may lessen the likelihood that services are rescheduled to other devices. The likelihood of success may be based on any suitable factors, such as factors associated with the current readiness of the remote device and factors associated with historical success rates associated with the device In some implementations, the likelihood of success may be based on the historical rate of success of the device where the slate of the remote device was similar to the current state or the projected state at the time of the remote service performance. In some cases, re-scheduling to another device is not an option, and a failed performance by a selected remote device negatively impacts the quality of service, possibly resulting in a financial penalty. Monitoring the likelihood of success of a remote document service may allow for document services with high likely failure rates to be terminated or sent to other devices.

In one implementation the cloud system includes multiple partners where an agreement is reached about a number of services that will be performed, such as the number of coupons that will be printed successfully within a particular time frame. It may be undesirable to send an instruction to print a coupon where it will not be successful or where the likelihood of success is more uncertain than for other devices, in some cases, additional coupons may not be allowed under the agreement and/or a job may be terminated before more may be sent, such as where a print job is waiting for paper to he filled. A predicted failure ask may be used to better tailor where the remote document services are sent, when they are sent, and/or which types of services are sent to a particular device.

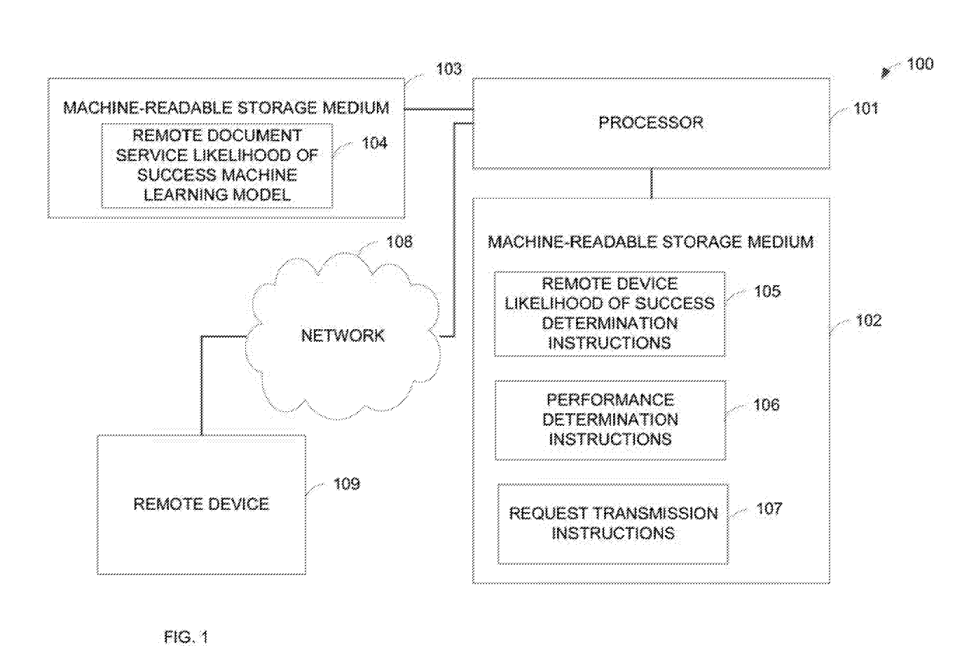

FIG. 1 is a block diagram illustrating one example of a computing system 100 to determine the likelihood of success of a remote document service. The computing system 100 includes a processor 101, a machine-readable storage medium 102, a machine-readable storage medium 103, and a remote device 109. In one implementation, the computing system 100 is a cloud based document services system The computing system 100 may include multiple electronic devices in communication with the processor 101. For example, the electronic devices may be associated with different users of a cloud service provided by the processor 101.

The processor 101 may receive requests for a document service from an electronic device for assigning a document service to one of a group of electronic devices and/or from devices requesting services to be performed at the particular device. For example, a document service may be provided such that someone without a device for performing a document service may request, a document service from their mobile device, and the processor 101 may determine a remote device to perform the service.

The machine-readable storage medium 103 may be any suitable storage accessible by the processor 101. The processor 101 may communicate directly with the storage 103 or via a network. The machine-readable storage medium 103 and the machine-readable storage medium 102 may be the same storage medium. In one implementation, the processor communicates directly with the machine-readable storage medium 102 and via a network with the machine-readable storage medium

The machine-readable storage medium 103 may include remote document service likelihood of success machine learning model 104. The model may be trained in any suitable manner. In one implementation, an event log of previously requested document services and their outcomes is mined such that events are processed into time series data. Relevant features and lags are determined from the grouped events, if the time series event information is binary; it may be converted to numerical time series data. The time series information may be exploited by multiple candidate methods to generate required predictions. Massively scalable parallelism may be applied, for example, using Hadoop. A prediction may be derived from the predictions generated by these candidate algorithms. Such derivation can be a simple “vote by majority”, or more sophisticated synthesis based on the track record of each candidate method on the particular type of prediction problem, such as the particular document service.

Performance metrics may be collected related to the service performance of a particular remote device selected based on the prediction and output, for example, to the machine-readable storage medium 103 for use in updating the remote document service likelihood of success model 104. In one implementation, batch learning is applied to an initial event log and subsequent event logs and/or real time results are analyzed for mis-matched predictions. The process may be parallelized, such as using a Hadoop. For example, single points of failure within the system may be identified. Updated training may be performed in real time or at particular time intervals and/or in response to a particular failure rate, a particular failure event, failure part prediction rate for parts in the pathway, or failed prediction rate. For example, information about tasks may be saved to a storage, such as the machine-readable storage medium 103, to he analyzed during the next training phase.

In one implementation, a machine learning method is applied to determine factors indicative of a likelihood of success and/or failure of a remote document service. The factors may be related to historical data of the device. For example, historical data may be analyzed in connection with current or projected future status of the device, such as at the time the document service is predicted to take place. The factors may also be related to current state information about the readiness and/or projected future readiness of the device in association with the historical factors, such as time stamped events related to an occurrence of a state status event indicating a problem (e.g., “out of paper”), an occurrence of a repair event (e.g., “access paper tray”), or an occurrence of a status change event (e.g., “out of paper” flag is turned off). A machine learning model may draw connections among the events to infer the effectiveness of a particular repair to address a particular problem. It may also use the time stamps to derive the timeliness of such repair. For example, the factors may be related to whether ink and paper are historically replenished In a timely manner. The events may he factored into the prediction of the likelihood of the occurrence of a problem in a future time and the likelihood and timeliness of the repair. The historical information may also include time-stamped device status information sensed periodically or with other transient sampling patterns or triggered by other events Examples include the ink consumptions recorded as each page being printed since the installation of a set of new ink cartridge. Another example includes number of pages of the papers in the tray sampled at different times. In some cases, the historical servicing events may be taken into account based on a particular current status. For example, the historically timeliness of replenishing paper to a printer may be taken into account where the printer currently has a status of no paper. In some cases, the event is taken into account regardless of the current status.

The network 108 may be any suitable network to allow the processor 101 to communicate with the remote device 109. The network 108 may be the Internet. The remote device 109 may be any remote device for performing a document service. For example, the remote device 109 may he a network connected printer or scanner. In one implementation, the remote device 109 is a network connected electronic device connected to a device for performing a document service. For example, the remote device 109 may be a user computer that communicates directly or via a network with a printer. There may be multiple components for communicating information about a request to the remote device 109, such as a router, firewall, and user electronic device.

In one implementation, the processor 101 communicates with multiple remote devices via the network 108. As an example, information about the response of multiple remote devices to requests from the processor 101 may be stored in the storage 103 for creating the remote document service machine learning model 104. In one implementation, there may be multiple remote devices, including the remote device 109, and the processor 101 may select among the remote devices a remote device to perform a document service. In one implementation, the remote device 109 requests to perform a document service, and the processor 101 selects to grant the privilege of performing the service to the remote device 109 based on the likelihood of success associated with the remote device 109 performing the document service.

The processor 101 may be a central processing unit (GPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101. For example, the machine-readable storage medium may include remote device likelihood of success determination instructions 105, performance determination instructions 106, and request transmission instructions 107.

The remote device likelihood of success determination instructions 105 may include instructions to determine the likelihood of success of a remote document service provided by the remote device 109 from processor 101 using the remote document service likelihood of success machine learning model 104 based on prediction using information related to a previous document service performed by the remote device 103 and/or other time stamped event Information.

The performance determination instructions 106 may include instructions to determine whether to perform the remote document service at the remote device 109 based on the likelihood of success For example, if there is a high likelihood of failure, a request to perform the document service at the remote device 109 may be terminated and/or a different remote device may be selected to perform the document service. The performance determination instructions 106 may include whether to perform the remote document service at the remote device based on a selection of where to perform the service. Tor example, a different remote device may have a higher likelihood of success and be selected to perform the service.

The request transmission instructions 107 may include instructions to transmit a request to the remote device 109 to perform the document service. In one implementation, a first electronic device determines whether the device is selected, and a second electronic device transmits information about the request. The remote device 109 may receive the request via the network 108. The remote device 109 may then perform the document service.

In one implementation, information about the response of the remote device 109 to the request may be transmitted back to the processor 101. For example, information about whether the remote device 109 performed the service and/or how long it took to complete the job may be transmitted back to the processor 101. Information about the status of the remote device 109 when the request was received by the remote device 109 and/or the status when the service was performed may be transmitted to the processor 101. In one implementation, the remote device 109 sends information about its current status to the processor 101 periodically, and the processor compares a time stamp associated with the different status information to time stamps for document service requests to the remote device. The information may be stored in the storage 103 to be used to create the remote document service likelihood of success model 104.

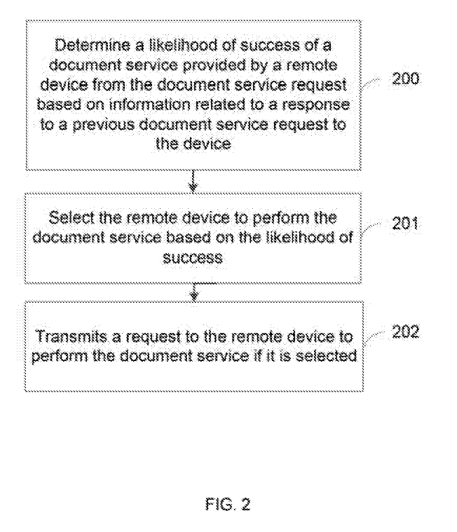

FIG. 2 is a flow chart illustrating one example of a method to determine the likelihood of success of a remote document service. For example, a processor communicating with an electronic device via a network may determine whether to send a request for a document service to the electronic device. The determination may be made based on the likelihood that the electronic device would successfully perform the document service. The method may be performed, for example, by the processor 101 in FIG. 1.

Beginning at 200, a processor determines a likelihood of success of a document service provided by a remote device from the document service request based on information related to a response to a previous document service request to the device. For example, the current state and/or project state at the time of the future request of the remote device and historical information related to the performance of the device when there was the same or similar state may be used to determine the likelihood of success. The likelihood of success may be determined for a particular remote device. The device may be, for example, a printer or scanner. The remote document service may be any suitable service that may be requested for a document, such as printing, scanning, or emailing. The likelihood of success may be based on a future time, and in some cases, a specific future point. For example, it may be desirable to locate a remote device for a job to be executed in a week.

The likelihood of success may be any suitable indication of a likely success rata of the document service. For example, it may be probabilistic likelihood in the form of a percentage or a binary determination that the document service Is likely to succeed. The probabilistic likelihood of success in a form of a percentage may be converted to a form of a binary Boolean by introducing a threshold value to compare with the probabilistic likelihood of success, such as where a probabilistic likelihood above a threshold is associated with a positive likelihood of success value. The likelihood of success may be determined in terms of likelihood of failure.

The likelihood of success may be determined, for example, in response to a request for a remote document service. The request may be from a processor automatically requesting jobs or from a user electronic device where a user requests a document service job.

The likelihood of success may be based on historical success data. For example, historical success data may be taken into account as it relates to current state information of the device. Historical success data related to when the device had the same or similar state as the current slate and/or projected state at the time of performance may be taken into account. A previous state may be inferred based on time stamps. For example, a paper jam event may have a time stamp, and a previous request for a document service may have a time stamp. The processor may determine whether the two coincide such that the event may have affected the performance, such as based on the difference in the time stamps. The historical success data may be associated with different factors related to success and/or failure. In some cases, the state information is related to an event. For example, a paper jam may be an event that has an associated time during the previous period of a request, and the device may currently have a paper jam. A remote device may have failed to print m the past due to a paper jam. The likelihood of success may be related to maintenance, such as human effort to keep the remote device in condition to perform operations. The historical information about how quickly a device is fixed, supplies replenished, or other maintenance is performed may affect the likelihood of success score. For example, a remote printer may be available but without paper. If the historical data indicates that paper is typically supplied very quickly, the request may be sent to the printer despite the tack of paper instead of to another device that is available but is unlikely to receive more paper quickly if it runs out in the middle of the print job.

The current state of the remote device may be taken into account for the likelihood of success score. For example, if the remote device is currently offline, the likelihood of success may be lower. However, historical data may be taken into account, such as where the device Is currently offline it is typically able to successfully perform a document service within the next hour. The current state and historical data may be factored in together, such as where a remote device is currently offline but is historically brought back online quickly. The processor may predict the likelihood of success at a future point in time, and the current state may be taken into account. For example, if the remote device is currently offline, the likelihood that if will also be offline in an hour when the service is requested may be taken into account.

The current state of the device and historical information may be weighted in any suitable manner. For example, the current state information and/or more recent historical data may be weighed more heavily.

In one implementation, the factors for determining the likelihood of success and their relative weight to one another is provided based on a machine learning model. The machine learning model may be used to analyze information related to historical and current information related to a device and whether it succeeded or failed to perform the remote document service. In some cases, a service is considered to have failed based on a time period. For example, the document service request may be cancelled If not performed within an hour of being transmitted. The machine learning model may be updated in parallel such that as multiple remote document service requests are being transmitted, the model is updated as the requests are deemed to have failed or succeeded.

The likelihood of success may be based on components in a pathway from the request to the remote device, such as where components between a requesting processor and the remote device may affect the success rate of the remote device. For example, a router or other component may be factored into the likelihood of success The likelihood of success of individual components in the pathway may be determined, and the likelihood of success of each component may be factored into the likelihood of success of the remote device. In one implementation, a likelihood of success is determined for a first pathway to the remote device, and if the likelihood of success is negative and/or below a threshold, the likelihood of success is determined using a different pathway to the remote device. In one implementation the likelihood of success of the remote device is determined based on different pathways, and the pathway providing the highest likelihood of success is used to reach the remote device. As an example, in a home based environment where the remote document service is to be performed in a consumer's home, the router may be a component considered for the likelihood of success. A consumer with a network that is down more often than other consumers may have a lower likelihood of success of being able to complete the remote document service successfully.

Continuing to 201, a processor selects the remote device to perform the document service based on the likelihood of success. The probabilistic likelihood of success may be in the form of a binary factor and/or a percentage chance of success. For example, a likelihood of success above a threshold may be associated with a positive value for the likelihood of success. The processor may select, the remote device where the likelihood of success is positive and/or above a threshold. In one implementation, the processor compares likelihood of success scores associated with multiple devices and selects a device based on the comparison For example, the device with the highest score may be selected, in some cases, other factors may be taken Into account. For example, the location of the device, price of the service, particular service contract, service level agreement, and/or services executed in parallel competing for the remote devices may be taken into account such that devices with a likelihood of success that is determined acceptable are then compared based on other factors for selection.

Moving to 202, a processor, transmits a request to the remote device to perform the document service if it is selected. If a particular pathway was considered, the request may be transmitted via the selected pathway. The remote device may receive the request and attempt to perform the document service, information related to the success or failure of the document service may be used to update information related to the device for future use. For example, if a phot job was unsuccessful due to a status of no ink and a failure to fix the problem, the information may be sent back to the processor that determined the likelihood of success, such as the processor 101 in FIG. 1, and saved, such as in the storage 103 in FIG. 1 to be used to predict the success of a future document service provided by the device Information about the success or failure may be saved to update factors for predicting the success for other devices. For example, information related to the device may be used to determine new factors and/or weights for exiting factors. In some cases the new factor may be combined with information related to current status and historical performance For example, the historical performance may be determined to be more or less indicative of success where the current status has a particular attribute.

In one implementation, the attributes used to determine the prediction are displayed or otherwise provided lo a user. For example, an administrator may review the attributes and/or weights of the attributes with the current model to make changes in addition to the automated learning process.

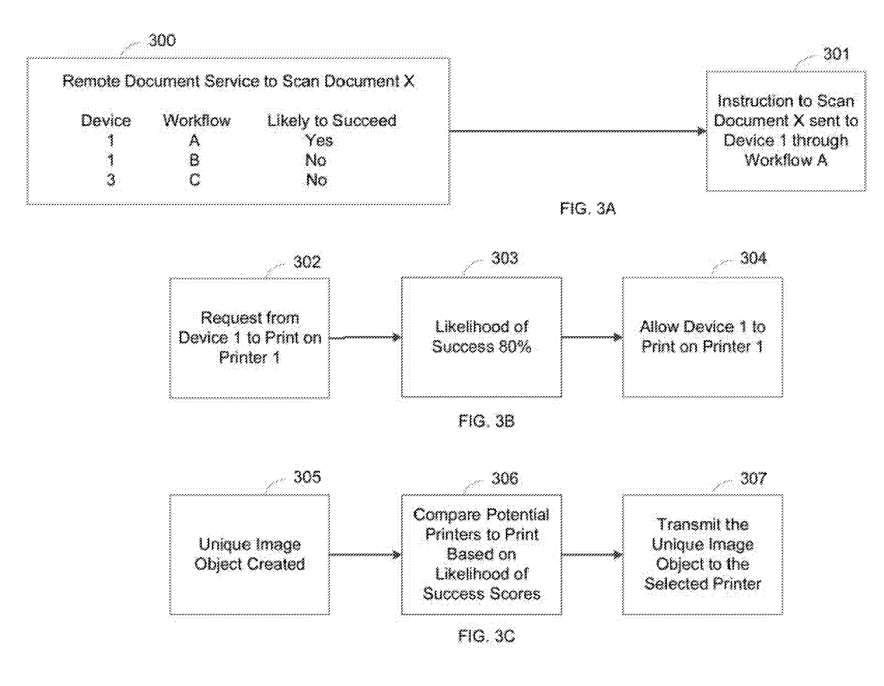

FIGS. 3A, 3B, and 3C are diagrams illustrating examples of determining the likelihood of success of remote document services. FIG. 3A shows an example of selecting a remote device to perform a remote document service. Table 301 shows likelihood success scores associated with different remote devices where different pathways are used. For example, Device 1 is likely to succeed with pathway A but not with pathway B, and Device 2 is unlikely to succeed. Device 1 is selected to scan Document X using pathway A because if is likely to succeed. At 302, the request is transmitted to Device 1.

FIG. 3B shows an example of determining whether to allow a device to perform a remote document service based on a likelihood of success. As an example, a remote document service may be performed on a prescription basis, and the remote document service may be transmitted to the device where it is likely to succeed. Otherwise, the remote device may be dented permission to perform the document service. A print subscription service may be provided where a new ink cartridge is supplied when projected that the remote printer is out of ink. The printer may be prevented from printing where determined that the likelihood of success is low. As an example, a request from Device 1 to print on an associated Printer 1 may be received. The likelihood of success may be 80%, and Device 1 may be allowed to print on Printer 1. In some cases, the processor for determining the likelihood of success sends the print job directly to Printer 1.

FIG. 3C shows an example of a cloud based system for generating a print image and selecting a printer to print the image based on the likelihood of success scores. FIG. 3C shows a unique image object created at 305, a comparison of potential printers based on likelihood of success scores at 306, and transmitting the unique image to the selected printer at 308. For example, a coupon service may be offered where there is a service level agreement between a vendor and print service to print a particular percentage of coupons. A set of unique coupon IDs and/or coupon images may be provided to a cloud service for printing. In some cases, there may be a service level agreement for the percentage that will be successfully printed. Likelihood of success scores of the set of potential printers may be compared to select a printer. The likelihood of success scores may take into account a particular time when the printing will occur and may taken into account the printing of multiple coupons, such as the queue of coupons to be printed at a particular device or routed through a particular pathway. Selecting printers based on likelihood of success scores may increase the likelihood that a service level agreement for successfully printing a particular number and/or percentage of coupons may be fulfilled.

1. A computing system, comprising:
a storage to store information related to a machine learning model to predict the likelihood of success of a remote document service; and
a processor to:
determine the likelihood of success of a document service performed by a remote device based on a comparison of information related to a previous document service performed by the remote device to the stored information; and
determine whether to perform the document service at the remote device based on the likelihood of success;
transmit a request to perform the document service to the remote device if determined to perform the document service at the remote device.

2. The computing system of claim 1, wherein the processor is further to select a second remote device to perform the document service where the likelihood of success is below a threshold.

3. The computing system of claim 1, wherein the processor is further to:
determine components for transmitting information about the request to the remote device and a likelihood of success associated with each of the components, respectively; and
wherein determining the likelihood of success for the remote device is based on the likelihood of success associated with the components.

4. The computing system of claim 1, wherein the likelihood of success is dependent on the likelihood that supplies to the remote device will be replenished within a particular time period.

6. A method, comprising:
determining, by a processor, a likelihood of success of a document service provided by a remote device from the document service request based on information related to a response to a previous document service request to the device;
select the remote device to perform the document service based on the likelihood of success; and
if the device is selected, transmit a request/to the device to perform the document service.

6. The method of claim 5, further comprising selecting a pathway to the remote device based on a likelihood of success of the selected pathway.

7. The method of claim 5, wherein selecting the remote device comprises:
comparing a likelihood of success score of multiple devices; and
selecting the remote device to perform the document service based on the comparison.

8. The method of claim 5, wherein determining a livelihood of success comprises determining a likelihood of success at a future time.

9. The method of claim 5, wherein information related to a response to a previous document service request to the device is analyzed based on a machine learning model.

10. The method of claim 5, further comprising using the outcome of the remote device performing the document service to update an attribute used to determine the likelihood of success of future document services.

11. The method of claim 10, wherein attributes used to determine the likelihood of success of future document services is updated in parallel as multiple devices perform remote document services.

12. A machine-readable non-transitory storage medium comprising instructions executable by a processor to:
determine to transmit information about a remote document service to a device based on a likelihood of success associated with the ability of the device to perform the remote document service,
wherein the likelihood of success is based on the performance history of the device and a factor associated with performance history and likelihood of success.

13. The machine-readable non-transitory storage medium of claim 12, further comprising instructions to select a device among a group of devices to perform the remote document service based on a comparison of a likelihood of success score associated with each of the devices within the group respectively.

14. The machine-readable non-transitory storage medium of claim 12, further comprising instructions to:
select a first and second pathway to the device;
determine a likelihood of success for the first pathway arid a likelihood of success of the second pathway; and
select a pathway to the device based on a comparison of the likelihood of success of the first pathway to the likelihood of success of the second pathway.

15. The machine-readable non-transitory storage medium of claim 12, wherein the likelihood of success is further based on Information related to the current state of the device and a factor associated with a current state and likelihood of success.
